(19) United States
(12) Patent Application Publication
(10) Pub. No.: US 2001/0002343 A1
(43) Pub. Date: May 31, 2001

(54) Electrical connector

(76) Inventor: Akio Suzuki, Tokyo (JP)

Correspondence Address: Yusuke Takeuchi, KANESAKA & TAKEUCHI, 1423 Powhatan Street, Alexandria, VA, 22314, US

(21) Appl. No.: 09/725,045

(22) Filed: Nov. 29, 2000

(30) Foreign Application Priority Data
Nov. 29, 1999 (JP) 11-337580

(51) Int. Cl. H01R 4/66; H01R 13/648

(52) U.S. Cl. 439/101; 439/108; 439/95; 439/607; 439/609; 439/610; 439/608

(57) ABSTRACT

An electrical connector (10) comprises a housing (11) having a receiving aperture (16) for receiving the ground pin of a mating connector and a ground terminal (13) having a U-shaped attaching section (13A), a contact tongue (13B) extending from an end of the attaching section (13A), and a connection section (13C) extending from the other end of the attaching section (13A), with the attaching section (13A) attached to the edge of the receiving aperture (16) such that the contact section (13B) is positioned inside the receiving aperture (16) and the connection section (13C) is outside the housing (11).

### BACKGROUND OF THE INVENTION

1. Field of the Invention

The present invention relates to electrical connectors and, particularly, to an electrical connector having a ground terminal.

2. Description of the Related Art

Japanese patent application Kokai No. 10-255906 discloses a connector of the type such as shown in FIG. 10.

In FIG. 10, a mating connector 60 has a pin-type ground terminal 61. A connector 50 comprises a housing 51 and a ground terminal 52 fixed to the housing. The ground terminal 52 has a fixing flange 52A, a female threaded section 52B, and an L-shaped connecting section 52C extending from the fixing flange 52A. The male thread section 53A of a bush 53 is threaded into the female thread section 52B. The bush 53 further has an intermediate section with a pair of openings 53B and a head section 53C with an increased diameter. The bush 53 is attached to a panel 54 by threading the male thread section 53A into the female thread section 52B of the ground terminal 52. A cavity is provided in the intermediate section and the head section 53C of the bush 53 to receive the pin terminal 61 of the mating connector 60. A U-shaped contact piece 55 is provided in the bush 53 and has a pair of contact portions 55A exposed into the cavity through the openings 53B.

When the mating connector 60 is plugged into the connector 50, the pin terminal 61 is brought into contact with the contact piece 55 in the cavity and grounded via the male thread section 53A and the ground terminal 52.

The above connector, however, has the following disadvantages.

First of all, it requires a large number of mechanical parts, including the bush 53, the contact piece 55, and the ground terminal 52 for grounding.

Secondly, some of the mechanical parts have complicated shapes. The bush 53 has three stepped portions below the head section 53C, the openings 53B, and the male thread section 53A. The contact piece 55 requires complex press operation, and the ground terminal 52 has a female thread section 52B.

As a result, the connector becomes large, and the assembling is complicated, resulting in the high electrical resistance and various contact resistance.

### SUMMARY OF THE INVENTION

Accordingly, it is an object of the invention to provide an electrical connector having a ground terminal sufficiently simple to make a compact connector.

An electrical connector according to the invention comprises a housing having a receiving aperture for receiving a ground pin of a mating connector; and a ground terminal having a U-shaped attaching section for attachment to an edge of the receiving aperture, a contact section provided at an end of the attaching section for making spring contact with the ground pin in the receiving aperture, and a connection section provided at the other end of the attaching section so as to project from the housing.

The ground terminal is easy to make by stamping and bending a metal sheet and attach with the U-shaped attaching section. When the ground pin of a mating connector enters the receiving aperture of the connector, the contact portion or tongue of the ground terminal makes spring contact with the side wall of the ground pin. The connection section of the ground terminal is connected to a ground circuit trace of a circuit board so that the ground pin is grounded to the circuit board via the contact section and connection section of the ground terminal. The housing may be provided with a groove at an edge of the receiving aperture for receiving the attaching section of the ground terminal so that the attaching section is positioned firmly.

A shield case may be provided over the housing such that the shield case make contact with part of the ground terminal. It may also be provided with a connection section so that the ground terminal is grounded to the circuit board via the connection section of the shield case. The shield case may be provided over the housing and made integrally with the ground terminal as a unit, making the structure simple. The shield case may be provided with a part for contact with a shield of the mating connector. The attaching section is provided on the side that the mating connector is plugged-in or the side opposite to the side that the mating connector is plugged-in.

### BRIEF DESCRIPTION OF THE DRAWINGS

FIG. 1(A) is a partially cutout, front elevational view of an essential portion of a connector according to an embodiment of the invention;

FIG. 1(B) is a top plan view of the essential portion thereof;

FIG. 1(C) is a side elevational view of the essential portion thereof;

FIG. 2(A) is a perspective view of a portion of the connector;

FIG. 2(B) is a perspective view of a ground terminal for the connector;

FIG. 3(A) is a side view of the ground terminal;

FIG. 3(B) is a rear view of the ground terminal;

FIG. 4 is a partially cutaway, front elevational view of the connector into which a mating connector is being plugged;

FIG. 5 is a partially cutaway, front elevation view of the connector in which the mating connector has been plugged;

FIG. 6(A) is a partially cutaway, front elevational view of a connector according to another embodiment of the invention;

FIG. 6(B) is a partially cutaway, side elevational view of the connector of FIG. 6(A);

FIG. 7(A) is a partially cutaway, front elevational view of a connector according to still another embodiment of the invention;

FIG. 7(B) is a side elevational view of the connector of FIG. 7(A);

FIG. 8(A)is a partially cutaway, front elevational view of a connector according to yet another embodiment of the invention;

FIG. 8(B) is a partially cutaway, side elevational view of the connector of FIG. 8(A);

FIG. 9(A) is a partially cutaway, front elevational view of a connector according to another embodiment of the invention;

FIG. 9(B) is a side elevational view of the connector of FIG. 9(A); and

FIG. 10 is a sectional view of a conventional connector.

### DESCRIPTION OF THE PREFERRED EMBODIMENTS

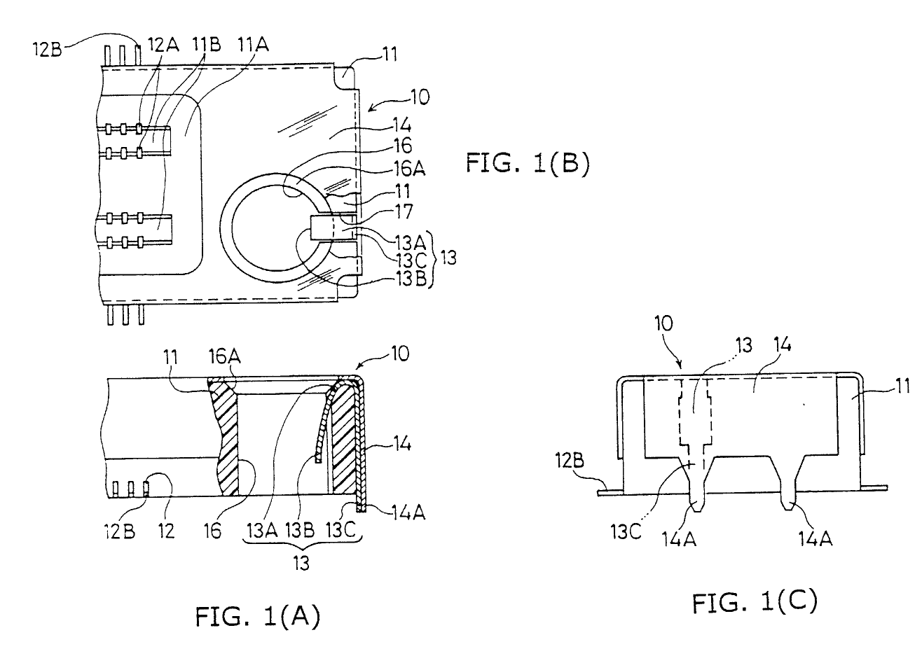

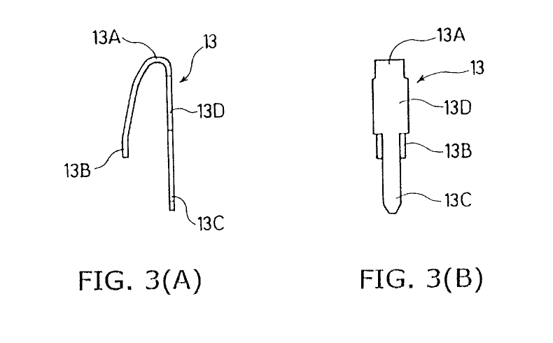

Embodiments of the invention will now be described with respect to FIGS. 1-9.

A connector 10 comprises an insulative housing 11, a plurality of signal contact elements 12, a ground terminal 13, and a shield case 14. The housing 11 is provided with a receiving recess 11A for receiving a plug section (not shown) of a mating connector. A pair of parallel arranging plates 11B are provided to support contact sections 12A of the contact elements 12 on opposite faces. The arranging plates 11B are made so as to enter the corresponding grooves provided in the plug section of a mating connector so that the contact sections 12A are brought into spring contact with the corresponding contact sections of the mating connector. As shown in FIG. 1(C), the connection sections 12B of the contact elements 12 project laterally from the bottom of the housing 11.

A receiving aperture 16 is provided at a corner of the housing 11 for receiving the ground pin of a mating connector. The receiving aperture 16 has a tapered top edge 16A for facilitating insertion of the ground pin. A shallow groove 17 extends from the tapered edge 16A to the outside of the housing for receiving the ground terminal 13. The shield case 14 is put on the housing 11 such that it is brought into contact with part of the ground terminal 13. It has holes at such positions that the plug section and the ground pin of a mating connector can enter the receiving recess 11A and the receiving aperture 16 of the connector 10. A plurality of connection legs 14A extends downwardly from sides of the shield case 14 beyond the bottom of the housing 11.

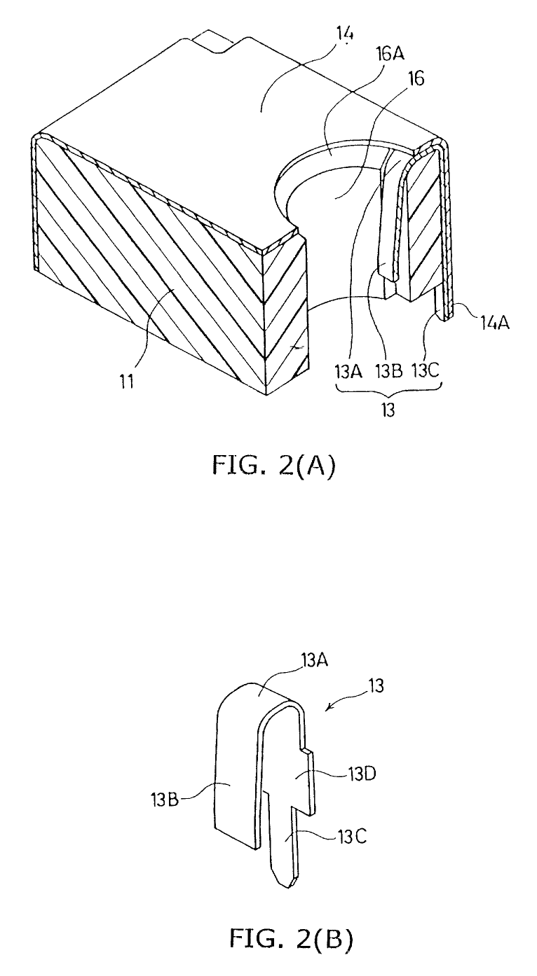

As shown in FIGS. 2(A)-(B) and 3(A)-(B), the ground terminal 13 is made from a metal sheet by stamping and bending so as to provide a U-shaped attaching section 13A, a contact section 13B at one end, and a connection leg 13C at the other end. An enlarged fixing section 13D is provided between the attaching section 13A and the connection section 13C and is press fitted in the groove 17 provided in a side wall of the housing 11.

The ground terminal 13 is attached to the housing 11 by fitting the fixing section 13A in the groove 17 before the shield case 14 is attached to the housing 11 such that the contact tongue 13B of the ground terminal 13 projects diagonally into the receiving aperture 16 of the housing 11 while the connection section 13C projects from the bottom of the housing 11. Then, the shield case 14 is fitted over the housing 11 so as to press the fixing section 13A for not only making electrical connection with the ground terminal 13 but also assuring the attachment between the ground terminal 13 and the housing 11. Also, it makes contact with the fixing section 13D and part of the connection section 13C of the ground terminal 13, assuring the electrical connection therebetween. The connector 10 is mounted on a circuit board such that the connection leg 13C of the ground terminal 13 and the connection leg 14A of the shield case 14 are put through the apertures of the circuit board and soldered to corresponding circuit traces.

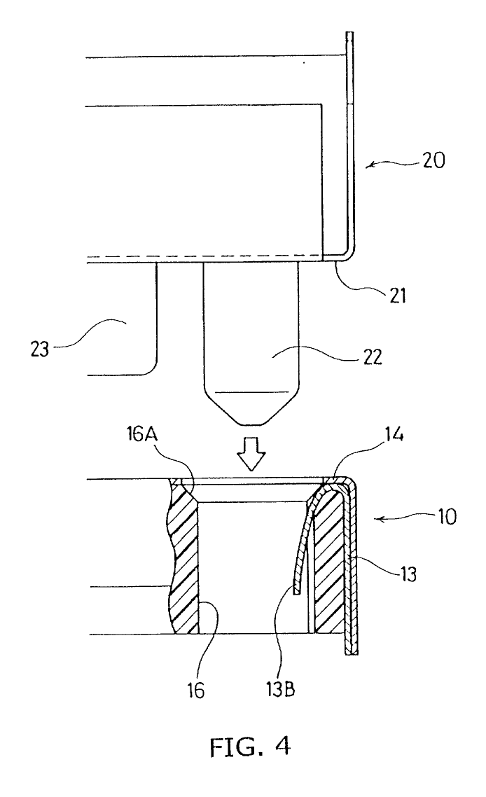

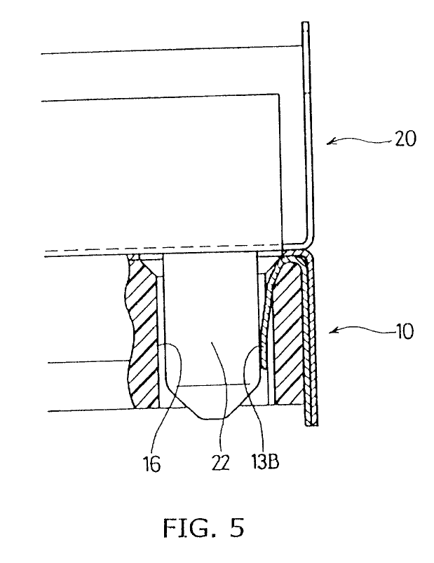

The electrical connector is plugged with the mating connector 20 as shown in FIGS. 4 and 5. The mating connector 20 comprises a housing, a shield case 21 fitted over the housing, and a ground pin 22 projecting from the bottom of the housing, which is provided with a downwardly extending plug section 23 having a pair of grooves (not shown) extending upwardly from the bottom of the plug section 23.

The mating connector 20 is plugged into the connector 10 as shown in FIG. 5 so that the plug section 23 is put in the receiving recess 11A of the connector 10, bringing the contact sections of contact elements in both the connectors into spring contact with each other while the ground pin 22 is put in the receiving aperture 16 of the connector 10 for spring contact with the contact tongue 13B of the spring terminal 13. Thus, the ground pin 22 is grounded to a predetermined trace of the circuit board via the ground terminal 13 and the connection leg 14A of the shield case 14.

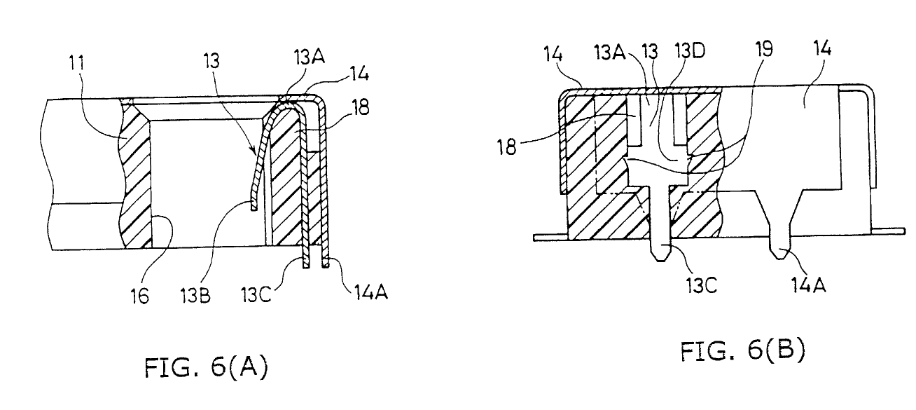

A variety of modifications for the ground terminal are possible. For example, the ground terminal may make contact with the shield case only at the fixing section and be attached directly to the housing. In FIGS. 6(A) and (B), the housing 11 is provided with a stepped slit 18 at a side wall so that the projections 19 of the fixing section 13D of a ground terminal 13 engage the side walls of the stepped slit 18. Consequently, the shield case 14 does not make any contact with the fixing section 13D but only the attaching section 13A of the connection terminal 13.

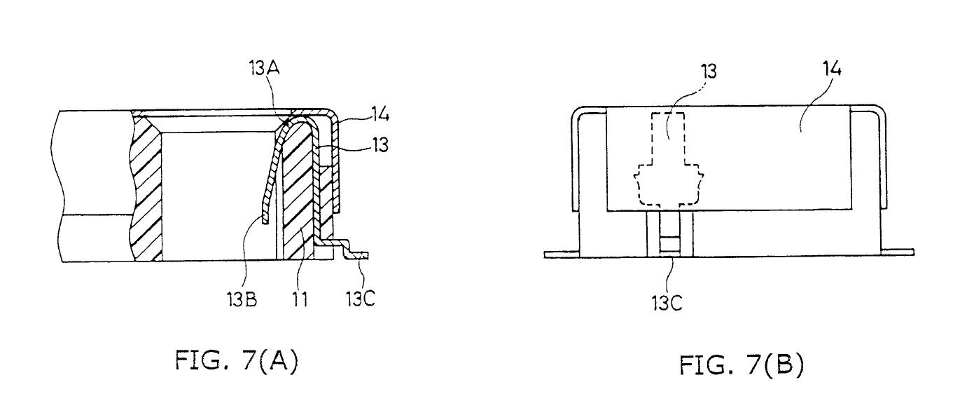

In FIGS. 7(A) and (B), the connection section 13C of a ground terminal 13 and the connection leg of a shield case 14 in FIGS. 6(A) and (B) are modified. The shield case 14 is different from that of FIGS. 6(A) and (B) because it has no connection leg. The connection section 13C of a ground terminal 13 extends laterally so that its tip is placed on a circuit board. Consequently, the shield case 14 is grounded to the connection section 13C of the ground terminal 13 via the attaching section 13A.

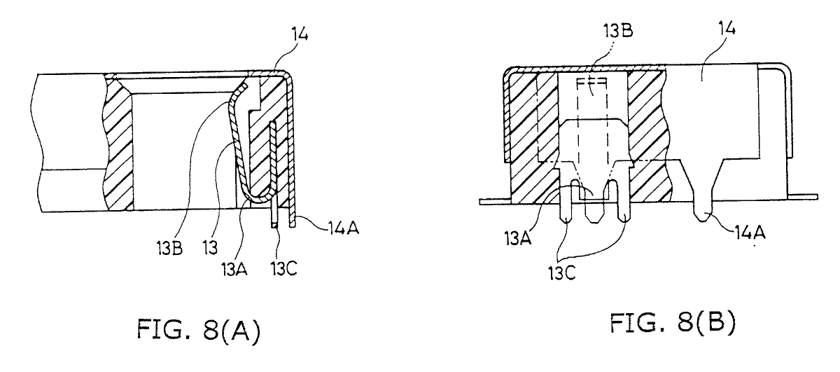

In FIGS. 8(A) and (B), the ground terminal 13 is attached to the housing from below or the side opposite to the side on which the mating connector is plugged-in. The ground terminal 13 has a U-shaped attaching section 13A at a lower portion thereof and a downwardly extending connection leg 13C. The ground terminal 13 does not make any contact with the shield case 14 which has connection legs 14A.

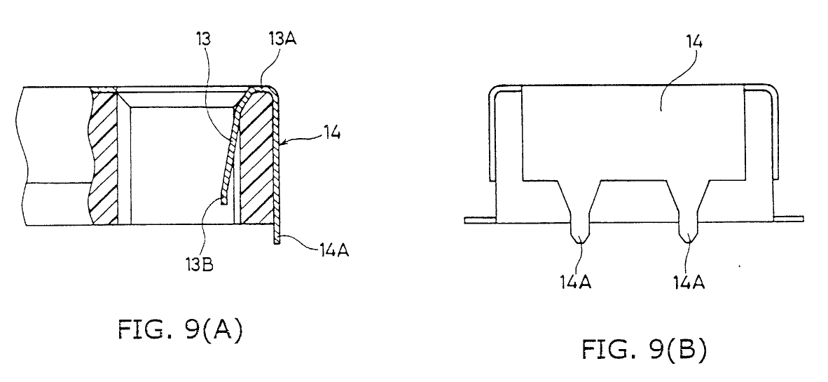

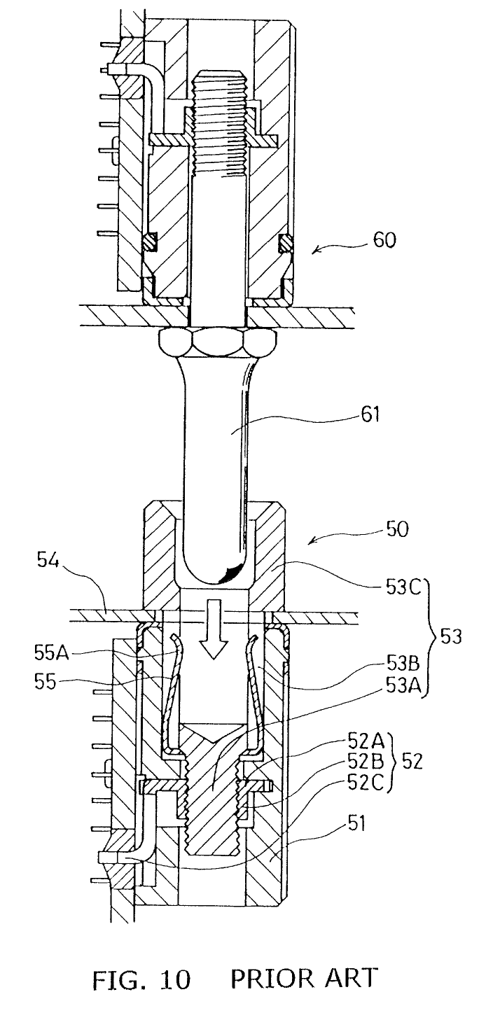

In FIGS. 9(A) and (B), a ground terminal and a shield case are made integrally as a unit, or a shield case 14 has an attaching section 13A and a contact section 13B as a unit. Consequently, the connection legs 14A of the shield case 14 also serve as the connection section of the ground terminal. The connection legs 14A may be bent on the surface of a circuit board for making surface-mount connection.

According to the invention, a metal sheet is formed to provide a U-shaped attaching section, and contact and connection sections at opposite ends of the attaching section so that the attaching section is fitted in the receiving groove of a housing for easy attachment. The number of mechanical parts is minimized, resulting in the simple and compact structure. Also, it is easy to not only make the ground terminal but also assemble the connector. As a result, the manufacturing cost is reduced. In addition, the electrical resistance is reduced and stabilized, enhancing the electrical characteristics.

1. An electrical connector comprising:
a housing having a receiving aperture for receiving a ground pin of a mating connector; and
a ground terminal having a U-shaped attaching section for attachment to an edge of said receiving aperture, a contact section provided at an end of said attaching section for making spring contact with said ground pin in said receiving aperture, and a connection section provided at the other end of said attaching section so as to project from said housing.

2. An electrical connector according to claim 1, wherein said housing is provided with a groove at an edge of said receiving aperture for receiving said attaching section of said ground terminal.

3. An electrical connector according to claim 1, which further comprises a shield case provided over said housing such that said shield case make contact with part of said ground terminal.

4. An electrical connector according to claim 1, which further comprises a shield case which is provided over said housing and made integrally with said ground terminal as a unit.

5. An electrical connector according to claim 3, wherein said shield case is provided with a part for contact with a shield of said mating connector.

6. An electrical connector according to claim 1, wherein said attaching section is provided on the side that said mating connector is plugged-in.

7. An electrical connector according to claim 1, wherein said attaching section is provided on an side opposite to the side that said mating connector is plugged-in.
